(19) United States
(12) Patent Application Publication
(10) Pub. No.: US 2024/0210109 A1
(43) Pub. Date: Jun. 27, 2024

(54) DEVICE AND METHOD FOR DRYING PARTICULATE MATERIAL

(71) Applicant: KRONOSPAN LUXEMBOURG S.A., Sanem (LU)

(72) Inventor: Dominik Willaczek, Bascharage (LU)

(73) Assignee: KRONOSPAN LUXEMBOURG S.A., Sanem (LU)

(21) Appl. No.: 18/288,456

(22) PCT Filed: Mar. 15, 2022
(86) PCT No.: PCT/EP2022/056684

§ 371 Date: Oct. 26, 2023

(51) Int. Cl. F26B 17/04; F26B 3/06; F26B 25/00

(52) U.S. Cl. CPC F26B 17/04; F26B 3/06; F26B 25/007; F26B 2200/24

(57) ABSTRACT

A device and method for drying particulate material, especially a wooden particulate material, in which the particulate material is placed on a conveyor belt, and during the conveying course, air is supplied. As the air passes through the particulate material, the supplied air removes humidity (along with finer particulate matter, such as dust) from the particulate matter. Subsequently, the humid air is removed in multiple separate streams and transferred to filter devices.

### RELATED APPLICATIONS

This application is a 371 nationalization of international patent application PCT/EP2022/056684, filed Mar. 15, 2022, the entirety of which is hereby incor-porated by reference.

### BRIEF DESCRIPTION OF THE DRAWING

FIG. 1 is an exemplary embodiment of a device for drying particulate matter according to the present disclosure.

### DETAILED DESCRIPTION OF EXEMPLARY EMBODIMENTS

The present disclosure relates to a device and a method for drying particulate material, especially wooden particulate material, in which the particulate material is placed on a conveyor belt, and during the conveying course is supplied with air. As the air passes through the particulate material, the supplied air removes humidity (along with finer particulate matter, such as, e.g. dust) from the particulate matter. Subsequently, the humid air is removed in multiple separate streams and transferred to filter devices.

Drying devices for drying particulate matter such as wooden chips have been known from the prior art. It is, however, problematic that these devices have high emissions in fine particulate matter, especially dust. However, the filtration of the air streams produced inside the drying device are technically quite ambitious since they have highly varying humidity depending in which drying stage they are produced.

It is an objective of the present disclosure to provide a device and a method for drying particulate material, in which subsequent filtration operation at optimum conditions and optimum filtrations conditions can be achieved.

According to a first aspect, the present disclosure relates to a device for drying particulate material, comprising at least one air-permeable conveyor belt, at least one of air supply for supplying air to a space above the at least one conveyor belt, a plurality of devices for removing air from a space below the at least one conveyor belt, said devices being arranged sequentially, or subsequently, along the at least one conveyor belt, a plurality of filter devices for filtering the air removed by the devices for removing the air, wherein said filter devices are arranged downstream of the devices for removing air, and at least one air exhaust for releasing filtered air into the environment which is arranged downstream of the filter devices.

According to the present disclosure the device comprises at least one air-parallel conveyor belt onto which the particulate material to be dried is placed. Preferably, the particulate material is placed on an outer end of the conveyor belt. At a plurality of locations air is supplied to a space above the at least one conveyor belt. Below the conveyor belt air is removed at a plurality of locations by a plurality of devices for removing air. These devices create a slight negative pressure. Accordingly, the supplied air passes through the particulate material to be dried and through the at least one air-permeable conveyor belt and is removed from below the conveyor belt. By means of this setting a constant air supply to the particulate matter and thus an effective drying of the particulate material is achieved. The air, being removed from a plurality of locations below the at least one conveyor belt is led to a plurality of filter devices in which fine-particulate material, such as dust is removed. After the removal of the fine-particulate matter, the cleaned air is released into the environment by means of at least one air exhaust such as a chimney.

The device according to the present disclosure enables an effective cleaning of the drying air before releasing said air into the environment.

According to a further preferred embodiment the total number of the devices for removing air exceeds the number of filter devices by factor of at least 1,5, preferably by a factor of at least 2, more preferably by a factor of at least 2,5, especially preferred by a factor of at least 3, wherein at least once, the air of 2 or more devices for removing air is grouped and enters one filter device, respectively. According to this embodiment, the number of devices for removing air exceeds the number of filter devices present in the device. At least once, two separate air streams generated by two separate devices for removing air are combined and collectively are entered into one filter device.

Preferably the total number of the plurality of devices for removing air exceeds the number of filter devices by a factor of 2, 3 or 4, wherein each time the air of 2, 3 or 4 devices for removing air is grouped and enters one filter device, respectively. According to this specific embodiment, generally speaking, the number of devices for removing air exceeds the number of filter devices by an integer multiple. The air streams generated by the devices for removing air are grouped by this integer multiple and the hence generated combined air streams are entered into the filter devices. Specifically, the device according to the present disclosure can comprise 2 to 40, preferably 4 to 20, especially preferred 10 to 14 devices for removing air. For example, if a devices comprises 3 times as many devices for removing air than filter devices, the air removed by three devices for removing air is combined and enters one filter device, only. Another example is that if the total number of devices for removing air in a device is 12 and 4 filter devices are present, the air removing devices for removing air are grouped into 4 air streams by combining the removed air from 3 devices for removing air, respectively. Each combined air stream enters one respective filter device. For example, the device according to the present disclosure can comprise 2 to 40, preferably 4 to 20, especially preferred 10 to 14 devices for removing air.

According to a specifically preferred embodiment, the device comprises n devices for removing air, with n≥3, wherein the air removed by each device i for removing air, wherein i is an integer selected from the interval 1≤i≤n, having a humidity Hᵢ, said humidity Hᵢ being greater than the humidity Hᵢ₊₁ of the air removed by the subsequent device i+1 for removing air, wherein a medium humidity H of the air removed by all devices for removing air is calculated as H=(Σᵢ₌₁ⁿ Hᵢ)/n and m filter devices for filtering the air, with m<n, wherein the air removed by at least two of said devices i for removing air is combined so that a humidity H_{c} of the combined air results, wherein 0.25≤H_{c}/H≤1.75, preferably 0.5≤H_{c}/H≤1.5, especially preferred 0.75≤H_{c}/H≤1.25, wherein each filter device α, with α≤1≤m, receives air from k_{α} of said devices for removing air, with k_{α}≥1 and Σ_{α} k_{α}=n, and said k_{α} devices for removing air are connected with only one of said filter devices α, so that a humidity H_{c} of the air received by each filter device results, wherein 0.25≤H_{c}/H≤1.75, preferably 0.5≤H_{c}/H≤1.5, especially preferred 0.75≤H_{c}/H≤1.25.

According to this specific embodiment, the device comprises a total number n of individual devices i for removing air. For example, if the device comprises 12 devices for removing air, the device denoted with i=1 accordingly is the first of the total of 12 devices for removing air, the device denominated with i=12 being the last device for removing air. The first device is defined as the device removing air for first time from the particulate material over its course on the at least one air-permeable conveyor belt, and the last as the device removing air for last time from the particulate material over its course on the at least one air-permeable conveyor belt. The other devices i for removing air are aligned in between these both ex-treme devices with i=1 or 12 in a subsequent manner such that the device for removing air denominated with i=2 is the second device for removing air aligned after the first device for removing air, the device for removing air denominated with i=3 is the third device for removing air aligned after the second device for removing air, and so on.

Now taking into consideration that, during the course of the particulate material over the conveyor belt, and at every location where additional air is supplied to and passed through the particulate material, the humidity of the particulate material decreases as the drying process continuously takes place, it can be assumed that the humidity of every air stream removed by the individual devices i for removing air has an individual humidity. Due to the fact that the humidity content of the particulate material decreases as the material is dried, the individual humidity of the individual air streams generated or removed by the individual devices i for removing air is different for each individual air stream, and as a matter of fact, is lower for each air stream produced by a device for removing air that is located downstream the conveyor belt, compared with the humidity of an air stream generated by a device for removing air that lies upstream the conveyor belt form said device for removing air.

Accordingly, the air removed by each device i is defined to have a (individual) humidity Hᵢ, said humidity Hᵢ being greater than the humidity Hᵢ₊₁ of the air removed by each subsequent or downstream device i+1 for removing air.

For air removed by all n devices i for removing air a (overall) medium humidity H of the air removed by all devices is calculated as H=(Σᵢ₌₁ⁿ Hᵢ)/n, which is the average humidity of the overall air removed from the particulate material.

The total number of filter devices comprised in the device for drying particulate material is set to be m. Since there are less filter devices present than devices for removing air (m<n), it follows that, at least once, the air removed by at least two of said devices i for removing air is combined and combinedly entered into one of the filter devices. In other words, each filter device (denominated with a in the following) with α≤1≤m, receives air from k_{α} of the devices for removing air, with k_{α}≥1 and Σ_{α} k_{α}=n, and said k_{α} devices for removing air are connected with only one of said filter devices α.

When doing so, the air streams are combined in a manner that a humidity H_{c} of the combined air results, wherein 0.25≤H_{c}/H≤1.75, preferably 0.5≤H_{c}/H≤1.5, especially preferred 0.75≤H_{c}/H≤1.25. The combination of the air flows accordingly is conducted in a manner that a preadjusted average humidity of the combined air stream results, thus enabling for constant and optimum filtration conditions.

The aforementioned embodiment relies on the fact that successive and continuous drying is affected during the course of the particulate material supplied on the conveyor belt. This means that the humidity of the particulate material at the beginning of the drying process, or, on the beginning of the conveyor belt, respectively, is higher than the humidity of the particulate material at the end of the process. According to the aforementioned embodiment, air removed by the respective devices for removing air is combined in a manner that airstreams removed at locations in the middle of the process, where the humidity of the particulate matter as an average value, are combined, whereas airstreams removed at the beginning and the end of the process are combined, in order to achieve an average humidity value which is close or similar to the humidity values of the airstreams removed in the middle of the process. According to the aforementioned embodiment, it can be guaranteed that all combined airstreams removed in the process have approximately the same humidity. Accordingly, the filter devices can be adapted for a single average humidity value to achieve an optimum filtration value.

Preferably, the ratio of the number of filter devices to the number of devices for removing air is set to be n/m≥2, and for every occurrence the air streams of at least 2 devices for removing air are combined and entered into one filter device. This means that always air streams generated by at least two devices for removing air are entered into 1 respective filter device. If the ratio n/m is set to be ≥3 or ≥4, the air streams generated by at least 3 or 4 devices for removing air, respectively are entered into 1 respective filter device.

Accordingly, it is especially preferred that n/m=k_{α}=2, 3 or 4.

For example, in a drying device comprising twelve devices for removing air and four filter devices, the air removed by the 1^{st}, 11^{th} and 12^{th} device for removing air are combined and enter a 1^{st} filter device, the airstreams removed by 2^{nd}, 3^{rd} and 10^{th} device for removing air are combined and enter a 2^{nd} filter device, the airstreams of a 4^{th}, 5^{th} and 9^{th} device for removing air are combined and enter a 3^{rd} filter device, whereas the airstreams are removed by the 6^{th}, 7^{th} and 8^{th} device for removing air are combined and enter a 4^{th} filter device.

According to another example, a drying device comprises twelve devices for removing air and six filter devices. The air removed by the 1^{st} and 12^{th} device for removing air are combined and enter a 1^{st} filter device, the airstreams removed by 2^{nd} and 11^{th} device for removing air are combined and enter a 2^{nd} filter device, the airstreams of a 3^{rd} and 10^{th} device for removing air are combined and enter a 3^{rd} filter device, the airstreams of a 4^{th} and 9^{th} device for removing air are combined and enter a 4^{rd} filter device, the airstreams of a 5^{th} and 8^{th} device for removing air are combined and enter a 5^{rd} filter device, whereas the airstreams are removed by the 6^{th} and 7^{th} device for removing air are combined and enter a 6^{th} filter device.

Preferably, each of the devices for removing air is designed to remove the equal amount of air per period of time.

The device according to present disclosure can comprise more air supplies for supplying air than devices for removing air.

For example, two air supplies can be arranged in between locations of two devices for removing air for all or some of the locations where air is removed.

Furthermore it is preferred that the at least one air supply comprises a device for heating air, such as a heat exchanger, gas burners, electrical air heaters or combinations thereof. Heat exchangers are especially preferred since they are especially adapted to heat up air for the purposes of the present disclosure, such as relatively low temperatures of air whilst having relatively high volume flows.

Especially preferred is the device comprises two conveyor belts, said conveyor belts being aligned above each other, wherein the particulate material is provided on a first conveyor belt, aligned over a second conveyor belt, and after having reached the end of the first conveyor belt is transferred by gravity to the second conveyor belt below the first conveyor belt.

The specific embodiment allows more compact construction of the device according to the present disclosure.

In the aforementioned embodiment, it is furthermore preferred that the first and second conveyor belt have opposite conveying directions.

Preferably the devices for removing air are fans.

Specifically, each filter device comprises at least one air inlet, at least on baffle plate, and at least one filter medium for removing dust-like material, said filter medium being allocated downstream OF the baffle plate.

Preferably, each filter device furthermore can be characterized by one or more of the following:
Each filter device is designed to filter at least 10.000 Bm³/h at 50° C., preferably at least 50.000 Bm³/h at 50° C., especially preferred at least 80.000 Bm³/h at 50° C., e.g. 80.000 to 150.000 Bm³/h at 50° C. “Bm³” is defined as “operating” cubic meters. The temperature defines the operating condition at which the flow rate was determined (i.e. 50° C. and 1.013 mbar). The operating cubic meters accordingly can be transferred and recalculated to every given condition such as different temperatures and thus recalculated as “standard” cubic meters.
Further, each filter device comprises at least one filter medium for removing dust-like material with a total surface of at least 500 m², preferably at least 800 m², especially preferred at least 1.000 m², e.g. 1.000 to 1.500 m².
Each filter device is characterized by an air ratio of at most 150 m³/m²/h, preferably at most 100 m³/m²/h, especially preferred at most 83,33 m³/m²/h. The lower the value, the lower the filter load/loading and corre-spondingly better the cleaning or the lower the impairment of the upstream process.
Each filter device comprises at least one filter medium in form of a bag, wherein a length of the bag preferably is from 2.000 to 10.000 mm, preferably from 3.000 to 7.000 mm, especially preferred from 4.000 to 6.000 mm, and/or a diameter of the bag is from 50 to 500 mm, preferably from 100 to 300 mm, especially preferred from 120 to 200 mm.
Each filter device comprises at least 100, preferably at least 200, especially preferred at least 350, e.g. 400 to 450 filter media in form of a bag, which preferably are arranged or operated in parallel.
In addition each filter device is characterized by an emission of <20 mg/Nm³, preferably <10 mg/Nm³, especially preferred <5 mg/Nm³. N stands for “Norm” (D) or “Normalized” (E) cubic meters. Determination can be made by extracting a partial volume flow through ultra-fine filters, fol-lowed by drying and weighing. The weight of dust is subsequently set in relation to the normalized air volume.

In addition it is preferred each filter device comprises at least one filter medium and at least one means for restoring the filter medium, comprising a device for providing a punch of compressed air to the filter medium.

The at least one filter device can comprise a filter medium made of a hydrophobic material.

In order to prevent the formation of condensates, it is preferred that each filter device comprises a heating device.

Especially preferred is the following embodiment of the filter device: The raw gas (air which carries all the dust) enters the filter device at the raw gas entrance—the streams impinge directly against a plate which ensures that bigger particles fall out of the air stream down to the bottom of the filter. Because of the plate in the filter device and the height of the filter entrance, the air stream needs to go down on the plate, which allows most of the dust to fall down into the funnel by itself. The air stream carries the finer particles into filter, where the particles are restrained on the outside of the filter hoses. This causes just cleaned gas to pass the cleaned gas room and afterwards leaves the filter. The cleaning of the filter hoses which are occupied with finer dust particles is performed by means of an electronic cleaning system. This system activates an electrical magnetic valve. After activating this valve, compressed air goes from the tank via a pipe to the filter hoses. A short-compressed air punch reaches the impure filter hoses—the hoses are inflated on a short-term basis and thus cleaned from the dust. This cleaning process is re-peated after a defined time period for the next filter hose line. Inside the filter device all the joints are flat and no stiffeners are located inside the filter device. Because of the missing stiffeners, there is no way dust can deposit on the inside of the filter device. The Collecting funnel below the filter housing is equipped with a trace heating system. This heating system prevents any kind of condensation inside the funnel. That way, no material deposition or blockage can occur in the funnel. The filter bags are made of a special material which is hydrophobic.

In a second aspect, the present disclosure relates to a method for drying particulate material, in which humid particulate material is provided on at least one air-permeable conveyor belt, air is supplied to at least one location at a space above the at least one conveyor belt, air is removed at a plurality of subsequent locations from a space below the at least one conveyor belt, the removed air is filtered at a plurality locations, and the filtered air is released to at least one location into the environment.

According to a preferred embodiment of the present disclosure, the number of the locations at which air is removed exceeds the number of locations at which the air is filtered by factor of at least 1.5, preferably by a factor of at least 2, more preferably by a factor of at least 2.5, especially preferred by a factor of at least 3, wherein at least once, the air of 2 or more locations where it is removed is grouped and transferred to a single location for filtering air, respectively.

Preferably the number of the locations at which air is removed exceeds the number of locations at which the air is filtered by factor of 2, 3 or 4, wherein each time the removed air is grouped and transferred to a single location for filtering air, respectively, for example the air is removed from 2 to 40, preferably 4 to 20, especially preferred 10 to 14 subsequent locations.

Especially it is preferred if the air is removed (3.1, 3.2, . . . ) at n locations i, wherein i is an integer selected from the interval 1≤i≤n, wherein the air removed (3.1, 3.2, . . . ) at each location i having a humidity Hᵢ, said humidity Hᵢ being greater than the humidity Hᵢ₊₁ of the air removed at each subsequent location i+1, wherein a medium humidity H of the air removed at all locations is calculated as H=(Σᵢ₌₁ⁿ Hᵢ)/n and m locations (4.1, 4.2, . . . ) for filtering the air, with men, wherein each location (4.1, 4.2, . . . ) a for filtering the air, with α≤1≤m, receives air from k_{α} of said locations for removing air (3.1, 3.2, . . . ), with k_{α}≥1 and Σ_{α} k_{α}=n, and said k_{α} locations for removing air (3.1, 3.2, . . . ) are connected with only one of said filter devices α, so that a humidity H_{c} of the air received by each location for filtering the air results, wherein 0.25≤H_{c}/H≤1.75, preferably 0.5≤H_{c}/H≤1.5, especially preferred 0.75≤H_{c}/H≤1.25.

Furthermore, an equal amount of air per time period can be removed.

In a specific embodiment according to the present disclosure, the device comprises an equal amount of air supplies for supplying air as devices for removing air.

Furthermore, it is preferred that the air supplied to at least one location at a space above the at least one conveyor belt is preheated, by means of heat exchangers, gas burners, electrical air heaters, or combinations thereof, especially to temperatures between 40 and 150° C., more preferably to temperatures in between 60 and 110° C., especially preferred to temperatures in between 90 and 100° ° C.

Depending on the requirements, drying can be carried out to a target moisture content. Alternatively, overdrying with the aim of minimum residual moisture <2% (weight/weight) can be performed.

According to another embodiment of the present disclosure, the humid particulate material is conveyed by means of a first conveyor belt, aligned over a second conveyor belt, and after having reached the end of the first conveyor belt is transferred by gravity to the second conveyor belt below the first conveyor belt.

Preferably, the first and second conveyor belt have opposite conveying directions.

For example, the particulate material can be chosen from wooden particulate ma-terials, especially wood chips, wood shavings, wood fibers, OSB strands, sawdust, or combinations hereof.

The present disclosure further is specified by the following exemplary embodiment, which is not to be understood to limit the present disclosure to this specific embodiment.

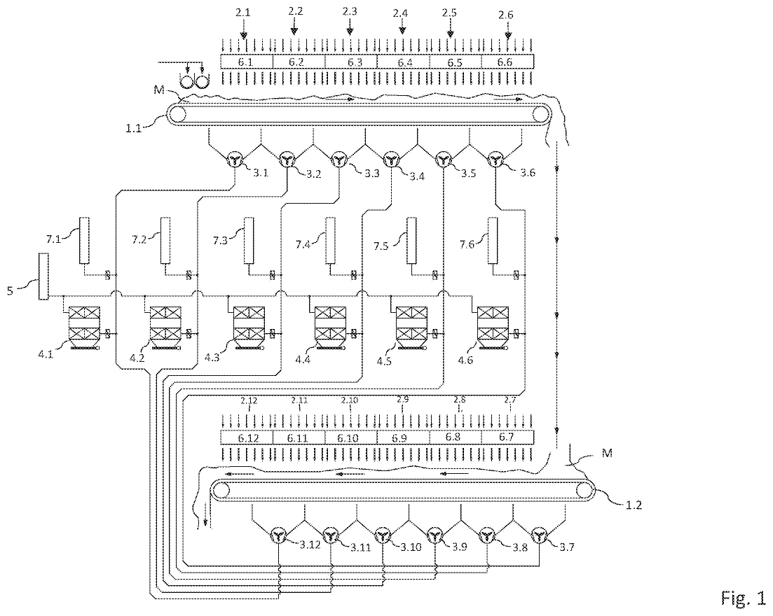

FIG. 1 shows an exemplary embodiment of a device for drying particulate material according to the disclosure. The device for drying particulate material comprises two conveyor belts 1.1 and 1.2 which are aligned above one another, the conveyor belt 1.1 being aligned above the conveyor belt 1.2. The conveying direction of the upper conveyor belt 1.1 is (as shown in FIG. 1) from left to right, whereas the conveying direction of the lower conveyor belt 1.2 is from right to left.

Both the upper and the lower conveyor belts 1.1 and 1.2 are air permeable, i.e. air can be passed through the conveyor belts.

Material to be dried, such as wood shavings, OSB strands, etc., is provided on the beginning of the first conveyor belt 1.1 on the left side. Material is provided to form a mat of said material on the first conveyor belt. After the material has reached the right end of the conveyor belt 1.1, it is poured onto the lower conveyor belt.

The particulate material M is supplied with air for drying at multiple locations. Accordingly, the device for drying particulate material has a plurality of air supplies, which are denoted with reference numerals 2.1, 2.2, 2.3, . . . 2.12. Each air supply supplies air to a location above the respective conveyor belt 1.1 and 1.2. Before being supplied to the space above the conveyor belt, air is preheated by heating devices 6.1, 6.2, 6.3, . . . 6.12, which preferably are heat exchangers.

The air supplied to above the conveyor belts passes through the mat of particulate material and through the conveyor belts 1.1 and 1.2, respectively, thus reducing the humidity of the particulate material. The air streams accordingly are enriched with humidity.

In order to ensure air passing through the particulate material and the conveyor belt, devices for removing air 3.1, 3.2, 3.3, . . . 3.12 are provided, which are capable to remove air from a space below the respective conveyor belt 1.1 and 1.2. These devices for removing air 3.1, 3.2, 3.3, . . . 3.12 can be fans or any other device which enables a negative pressure and thus an air-suction.

The air removed by the devices for removing air 3.1, 3.2, 3.3, . . . 3.12 subsequently is led to filter devices 4.1, 4.2, 4.3, 4.4, 4.5 and 4.6. It is apparent that the device for drying particulate material comprises 3 times as many devices for removing air 3.1, 3.2, 3.3, . . . 3.12 than filter devices 4.1, 4.2, 4.3, 4.4, 4.5 and 4.6. Accordingly, the air removed by respectively three devices for removing air 3.1, 3.2, 3.3, . . . 3.12 is combined, and the combined air stream is entered into one filter device 4.1, 4.2, 4.3, 4.4, 4.5 or 4.6.

The humidity of air removed by the devices for removing air 3.1, 3.2, 3.3, . . . 3.12 decreases with every further step of supplying air to the particulate material. Accordingly, air removed further downstream of the device or the process has a lower humidity as air removed further to the front end of the device or the process. For example, the air stream removed by device 3.1 has a higher humidity than the air stream removed by device 3.2, the humidity of which again is higher than the air stream removed by device 3.3, and so on. The lowest humidity can be expected in the air stream removed by device 3.12, i.e. at the final drying stage, after which the particulate material is removed from the device in dry state.

The air streams removed by the devices for removing air 3.1, 3.2, 3.3, . . . 3.12 then are combined in a manner that a humidity of the combined air streams results which is close to a calculated average humidity. The average humidity can be calculated by measuring the humidity of every air stream removed by the devices for removing air 3.1, 3.2, 3.3, . . . 3.12, and forming the arithmetic average. In order to do so, the air of the combined streams is combined in a manner that the resulting humidity of the combined air stream is close to the average humidity calculated. This is preferably done for every combined air stream, thus ensuring that every air stream entering a filter device has more or less comparable or even close to the same humidity. According to equal conditions of the air streams, each filter device can be equally designed and operated in the same manner, thus ensuring equal filtering conditions overall process.

In the provided example, the drying device comprises twelve devices for removing air 3.1, 3.2, 3.3, . . . 3.12, and six filter devices 4.1, 4.2, 4.3, 4.4, 4.5 and 4.6. The air removed by the 1^{st} (3.1) and 12^{th} (3.12) device for removing air are combined and enter a 1^{st} filter device (4.1), the airstreams removed by 2^{nd} (3.2) and 11^{th} (3.11) device for removing air are combined and enter a 2^{nd} filter device (4.2), the air-streams of a 3^{rd} (3.3) and 10^{th} (3.10) device for removing air are combined and enter a 3^{rd} filter device (4.2), the airstreams removed by the 4^{th} (3.4) and 9^{th} (3.9) device for removing air are combined and enter a 4^{th} filter device (4.4), and so on.

Accordingly, it can be guaranteed that each of the air streams entering the respective filter device 4.1 to 4.6 has approximately the same humidity. Thus, the filter devices can be—regarding their filtering characteristics—optimized for an average humidity.

The filtered air leaving the filter devices 4.1 to 4.6 is collected and released into the environment via chimney 5.

Additionally, each line leading the air to a respective filter device 4.1 to 4.6 comprises an emergency release 7.1 to 7.6, allowing in a case of emergency, a malfunc-tion of a filter devices 4.1 to 4.6, or their maintenance, a temporary releasing of unfiltered air into the environment, without the necessity to shut down the com-plete drying device.

1. A device for drying particulate material, comprising:
at least one air-permeable conveyor belt,
at least one of air supply for supplying air to a space above the at least one conveyor belt,
a plurality of devices for removing air from a space below the at least one conveyor belt, said devices for removing air being arranged sequentially along the at least one conveyor belt,
a plurality of filter devices for filtering the air removed by the devices for removing air, wherein said filter devices are arranged downstream of the devices for removing air, and
at least one air exhaust for releasing filtered air into the environment which is arranged downstream of the filter devices.

2. The device according to claim 1, wherein the number of the plurality of devices for removing air exceeds the number of filter devices by a factor of at least 1.5, wherein at least once, the air of 2 or more devices for removing air is grouped and enters one filter device.

3. The device according to claim 2, wherein the number of the plurality of devices for removing air exceeds the number of filter devices by a factor of 2, 3 or 4, wherein each time the air of 2, 3 or 4 devices for removing air is grouped and enters one filter device.

4. The device according to claim 3, wherein the device comprises 2 to 40 for removing air.

5. The device according to claim 1, comprising n devices for removing air, with n≥3, wherein;
the air is configured to be removed by each device i for removing air, wherein i is an integer selected from the interval 1≤i≤n,
the air has a humidity Hᵢ, said humidity Hᵢ being greater than the humidity Hᵢ₊₁ of the air removed by the subsequent device i+1 for removing air,
a medium humidity H of the air removed by all devices for removing air is calculated as H=(Σᵢ₌₁ⁿ Hᵢ)/n and m filter devices for filtering the air, with m<n,
each filter device α, with α≤1≤m, receives air from k_{α} of said devices for removing air, with k_{α}≥1 and Σ_{α} k_{α}=n, and said k_{α} devices for removing air are connected with only one of said filter devices α, so that a humidity H_{c} of the air received by each filter device results, and
0.25≤H_{c}/H≤1.75.

6. The device according to claim 5, wherein n/m=k_{α}=2, 3 or 4.

7. The device according to claim 1, wherein each of the devices for removing air is designed to remove an equal amount of air per time period.

8. The device according to claim 1, comprising more air supplies for supplying air than devices for removing air.

9. The device according to claim 1, wherein the at least one air supply comprises a device for heating air comprising a heat exchanger, gas burners, electrical air heaters, or combinations thereof.

10. The device according to the claim 1, comprising two conveyor belts, said conveyor belts being aligned above each other, wherein the particulate material is provided on a first conveyor belt, aligned over a second conveyor belt, and after having reached the end of the first conveyor belt is transferred by gravity to the second conveyor belt below the first conveyor belt.

11. The device according to the claim 10, wherein the first and second conveyor belts have opposite conveying directions.

12. The device according to claim 1, wherein the devices for removing air are fans.

13. The device according to claim 1, wherein each filter device comprises at least one air inlet, at least on baffle plate, and at least one filter medium for removing dust-like material, said filter medium being allocated downstream of the baffle plate.

14. The device according to claim 1, wherein each filter device:
is configured to filter at least 10.000 Bm³/h at 50° C.,
comprises at least one filter medium for removing dust-like material with a total surface of at least 500 m²,
comprises an air ratio of at most 150 m³/m²/h,
comprises at least one filter medium in a form of a bag, wherein a length of the bag is from 2.000 to 10.000 mm, and/or a diameter of the bag is from 50 to 500 mm,
comprises at least 100 filter media in the form of a bag, comprising an emission of <20 mg/Nm.

15. The device according to claim 1, wherein each filter device comprises at least one filter medium and at least one means for restoring the filter medium, comprising a device for providing a punch of compressed air to the filter medium.

16. The device according to claim 1, wherein the at least one filter device comprises a filter medium made of a hydrophobic material.

17. The device according to claim 1, wherein the at least one filter device comprises a heating device preventing the formation of condensates.

18. A method for drying particulate material, comprising:
providing humid particulate material on at least one air-permeable conveyor belt,
supplying air to at least one location to at a space above the at least one conveyor belt,
removing air at a plurality of subsequent locations from a space below the at least one conveyor belt,
filtering the removed air at a plurality of locations, and
releasing the filtered air into the environment at at least one location environment.

19. The method according to claim 18, wherein the air the number of the locations at which air is removed exceeds the number of locations at which the air is filtered by a factor of at least 1.5, wherein at least once, the air of 2 or more locations where air is removed is grouped and transferred to a single location for filtering air.

20. The method according to claim 18, wherein the number of the locations at which air is removed exceeds the number of locations at which the air is filtered by a factor of 2, 3 or 4, wherein each time the removed air is grouped and transferred to a single location for filtering air.

21. The method according to 18, wherein the air is removed from 2 to 40 subsequent locations.

22. The method according to claim 18, wherein:
the air is removed at n locations i, wherein i is an integer selected from the interval 1≤i≤n, wherein the air removed at each location i having an humidity Hᵢ, said humidity Hᵢ being greater than the humidity Hᵢ₊₁ of the air removed at each subsequent location i+1, wherein a medium humidity H of the air removed at all locations is calculated as H=(Σᵢ₌₁ⁿ Hᵢ)/n and m locations for filtering the air, with m<n, wherein each location α for filtering the air, with α ≤1≤m, receives air from k_{α} of said locations for removing air, with k_{α}≥1 and Σ_{α} k_{α}=n, and said k_{α} locations for removing air are connected with only one of said filter devices α, so that a humidity H_{c} of the air received by each location for filtering the air results, wherein 0.25≤H_{c}/H≤1.75.

23. The method according to claim 22, wherein n/m=k_{α}=2, 3 or 4.

24. The method according to claim 18, wherein at each location for removing air an equal amount of air per time period is removed.

25. The method according to claim 18, wherein there are more air supplies for supplying air than devices for removing air.

26. The method according to claim 18, wherein the air supplied to at least one location at a space above the at least one conveyor belt is preheated, by heat exchangers, gas burners, electrical air heaters, or combinations thereof, to temperatures between 40 and 150° C.

27. The method according claim 18, wherein the humid particulate material is conveyed by a first conveyor belt aligned over a second conveyor belt, and after having reached the end of the first conveyor belt is transferred by gravity to the second conveyor belt below the first conveyor belt.

28. The method according to claim 27, wherein the first and second conveyor belts have opposite conveying directions.

29. The method according to claim 18, wherein the particulate material is a wooden particulate material, comprising wood chips, wood shavings, wood fibers, OSB strands, sawdust, or combinations thereof.
